(19) United States
(12) Patent Application Publication
(10) Pub. No.: US 2017/0093537 A1
(43) Pub. Date: Mar. 30, 2017

(54) A METHOD, APPARATUS AND SYSTEM

(71) Applicant: Nokia Solutions and Networks Oy, Espoo (FI)

(72) Inventors: Xiaoyi Wang, Beijing (CN); Sean Kelley, Hoffman Estates, IL (US); Anand Bedekar, Glenview, IL (US)

(21) Appl. No.: 15/308,173

(22) PCT Filed: May 5, 2014
(86) PCT No.: PCT/US14/36771

§ 371 Date: Nov. 1, 2016

(51) Int. Cl. H04L 5/00; H04W 72/04

(52) U.S. Cl. CPC H04L 5/0035; H04W 72/0406; H04W 92/20

(57) ABSTRACT

There is provided a method comprising, at a first base station in response to a request including information relating to one or more resource allocations of at least a first cell, causing information corresponding to at least one of the resource allocations to be sent, the information indicative of a scheduling benefit obtained by a cell associated with the first base station if the resource is allocated to the at least one first cell.

### FIELD

The present application relates to a method, apparatus and system and in particular but not exclusively, to coordinated multipoint communication systems.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communications may comprise, for example, communication of data for carrying communications such as voice, electronic mail (email), text message, multimedia and/or content data and so on. Non-limiting examples of services provided include two-way or multi-way calls, data communication or multimedia services and access to a data network system, such as the Internet.

In a wireless communication system at least a part of communications between at least two stations occurs over a wireless link. Examples of wireless systems include public land mobile networks (PLMN), satellite based communication systems and different wireless local networks, for example wireless local area networks (WLAN) or systems based on LTE or LTE-A architecture. The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. An example of attempts to solve the problems associated with the increased demands for capacity is an architecture that is known as the long-term evolution (LTE) of the Universal Mobile Telecommunications System (UMTS) radio-access technology. The LTE is being standardized by the 3^{rd} Generation Partnership Project (3GPP). The various development stages of the 3GPP LTE specifications are referred to as releases. The aim of the standardization is to achieve a communication system with, inter alia, reduced latency, higher user data rates, improved system capacity and coverage, and reduced cost for the operator. In the following certain example embodiments are explained with reference to a wireless or mobile communication system serving mobile communication devices.

### SUMMARY

In a first aspect there is provided a method comprising, at a first base station in response to a request including information relating to one or more resource allocations of at least a first cell, causing information corresponding to at least one of the resource allocations to be sent, the information indicative of a scheduling benefit obtained by a cell associated with the first base station if the resource is allocated to the at least one first cell.

The at least one first cell may be associated with at least one second base station.

The method may comprise receiving the request from a base station other than the first base station.

The method may comprise receiving the request from the second base station.

The method may comprise causing the information to be transmitted in an X2 interface.

The method may comprise causing the response to be sent periodically.

The request may include periodicity information.

The method may comprise causing the response to be sent periodically in dependence on the periodicity information.

The information relating to one or more resource allocations may be one or more coordinated multipoint hypotheses.

The information relating to one or more resource allocations may be a list of one or more base stations and/or cells.

The method may comprise determining at least one resource allocation for at least one of the base stations or cells of the list.

The determined resource allocation may be a coordinated multipoint hypothesis.

The method may comprise selecting a set of the one or more resource allocations from the request for sending a value according to the resource allocations.

In a second aspect there is provided a method comprising causing a request to be sent to a first base station, the request including information relating to one or more resource allocations of at least a first cell and receiving information corresponding to at least one of the resource allocations, the information indicative of a scheduling benefit obtained by a cell associated with the first base station if the resource is allocated to the at least one first cell.

The at least one first cell may be associated with at least one second base station.

The method may comprise causing the request to be sent from a base station other than the first base station.

The method may comprise causing the request to be sent from the second base station.

The method may comprise comprising causing the request to be transmitted in an X2 interface

The method may comprise determining the resource allocation to be sent in dependence of coordination architecture.

The coordination architecture may be a centralised coordination architecture or a distributed coordination architecture.

The request may include periodicity information.

The information relating to one or more resource allocations may be a configuration of one or more coordinated multipoint hypotheses.

The information relating to one or more resource allocations may be a list of one or more base stations and/or cells.

In a third aspect there is provided an apparatus, said apparatus comprising means for at a first base station in response to a request including information relating to one or more resource allocations of at least a first cell, causing information corresponding to at least one of the resource allocations to be sent, the information indicative of a scheduling benefit obtained by a cell associated with the first base station if the resource is allocated to the at least one first cell.

The at least one first cell may be associated with at least one second base station.

The apparatus may comprise means for receiving the request from a base station other than the first base station.

The apparatus may comprise means for receiving the request from the second base station.

The apparatus may comprise means for causing the information to be transmitted in an X2 interface.

The apparatus may comprise means for causing the response to be sent periodically.

The request may include periodicity information.

The apparatus may comprise means for causing the response to be sent periodically in dependence on the periodicity information.

The information relating to one or more resource allocations may be one or more coordinated multipoint hypotheses.

The information relating to one or more resource allocations may be a list of one or more base stations and/or cells.

The apparatus may comprise means for determining at least one resource allocation for at least one of the base stations or cells of the list.

The determined resource allocation may be a coordinated multipoint hypothesis.

The apparatus may comprise means for selecting a set of the one or more resource allocations from the request for sending a value according to the resource allocations.

In a fourth aspect there is provided an apparatus, said apparatus comprising means for causing a request to be sent to a first base station, the request including information relating to one or more resource allocations of at least a first cell and means for receiving information corresponding to at least one of the resource allocations, the information indicative of a scheduling benefit obtained by a cell associated with the first base station if the resource is allocated to the at least one first cell.

The at least one first cell may be associated with at least one second base station.

The apparatus may comprise means for causing the request to be sent from a base station other than the first base station.

The apparatus may comprise means for causing the request to be sent from the second base station.

The apparatus may comprise means for causing the request to be transmitted in an X2 interface

The apparatus may comprise means for determining the resource allocation to be sent in dependence of coordination architecture.

The coordination architecture may be a centralised coordination architecture or a distributed coordination architecture.

The request may include periodicity information.

The information relating to one or more resource allocations may be a configuration of one or more coordinated multipoint hypotheses.

The information relating to one or more resource allocations may be a list of one or more base stations and/or cells.

In a fifth aspect there is provided an apparatus comprising at least one processor and at least one memory including a computer program code, the at least one memory and the computer program code configured to, with the at least one processor, cause the apparatus at least to: at a first base station in response to a request including information relating to one or more resource allocations of at least a first cell, cause information corresponding to at least one of the resource allocations to be sent, the information indicative of a scheduling benefit obtained by a cell associated with the first base station if the resource is allocated to the at least one first cell.

The at least one first cell may be associated with at least one second base station.

The at least one memory and the computer program code may be configured to, with the at least one processor, cause the apparatus to receive the request from a base station other than the first base station.

The at least one memory and the computer program code may be configured to, with the at least one processor, cause the apparatus to receive the request from the second base station.

The at least one memory and the computer program code may be configured to, with the at least one processor, cause the apparatus to cause the information to be transmitted in an X2 interface.

The at least one memory and the computer program code may be configured to, with the at least one processor, cause the apparatus to causing the response to be sent periodically.

The request may include periodicity information.

The at least one memory and the computer program code may be configured to, with the at least one processor, cause the apparatus to cause the response to be sent periodically in dependence on the periodicity information.

The information relating to one or more resource allocations may be one or more coordinated multipoint hypotheses.

The information relating to one or more resource allocations may be a list of one or more base stations and/or cells.

The at least one memory and the computer program code may be configured to, with the at least one processor, cause the apparatus to determine at least one resource allocation for at least one of the base stations or cells of the list.

The determined resource allocation may be a coordinated multipoint hypothesis.

The at least one memory and the computer program code may be configured to, with the at least one processor, cause the apparatus to select a set of the one or more resource allocations from the request for sending a value according to the resource allocations.

In a sixth aspect there is provided an apparatus comprising at least one processor and at least one memory including a computer program code, the at least one memory and the computer program code configured to, with the at least one processor, cause the apparatus at least to cause a request to be sent to a first base station, the request including information relating to one or more resource allocations of at least a first cell and receive information corresponding to at least one of the resource allocations, the information indicative of a scheduling benefit obtained by a cell associated with the first base station if the resource is allocated to the at least one first cell.

The at least one first cell may be associated with at least one second base station.

The at least one memory and the computer program code may be configured to, with the at least one processor, cause the apparatus to cause the request to be sent from a base station other than the first base station.

The at least one memory and the computer program code may be configured to, with the at least one processor, cause the apparatus to cause the request to be sent from the second base station.

The at least one memory and the computer program code may be configured to, with the at least one processor, cause the apparatus to cause the request to be transmitted in an X2 interface

The at least one memory and the computer program code may be configured to, with the at least one processor, cause the apparatus to determine the resource allocation to be sent in dependence of coordination architecture.

The coordination architecture may be a centralised coordination architecture or a distributed coordination architecture.

The request may include periodicity information.

The information relating to one or more resource allocations may be a configuration of one or more coordinated multipoint hypotheses.

The information relating to one or more resource allocations may be a list of one or more base stations and/or cells.

In a seventh aspect there is provided a computer program product for a computer, comprising software code portions for performing the steps of the above method when said product is run on the computer.

In an eighth aspect there is provided a computer program embodied on a computer-readable storage medium, the computer program comprising program code for controlling a process to execute a process, the process comprising at a first base station in response to a request including information relating to one or more resource allocations of at least a first cell, causing information corresponding to at least one of the resource allocations to be sent, the information indicative of a scheduling benefit obtained by a cell associated with the first base station if the resource is allocated to the at least one first cell.

The at least one first cell may be associated with at least one second base station.

The process may comprise receiving the request from a base station other than the first base station.

The process may comprise receiving the request from the second base station.

The process may comprise causing the information to be transmitted in an X2 interface.

The process may comprise causing the response to be sent periodically.

The request may include periodicity information.

The process may comprise causing the response to be sent periodically in dependence on the periodicity information.

The information relating to one or more resource allocations may be one or more coordinated multipoint hypotheses.

The information relating to one or more resource allocations may be a list of one or more base stations and/or cells.

The process may comprise determining at least one resource allocation for at least one of the base stations or cells of the list.

The determined resource allocation may be a coordinated multipoint hypothesis.

The process may comprise selecting a set of the one or more resource allocations from the request for sending a value according to the resource allocations.

In a ninth aspect there is provided a computer program embodied on a computer-readable storage medium, the computer program comprising program code for controlling a process to execute a process, the process comprising causing a request to be sent to a first base station, the request including information relating to one or more resource allocations of at least a first cell and receiving information corresponding to at least one of the resource allocations, the information indicative of a scheduling benefit obtained by a cell associated with the first base station if the resource is allocated to the at least one first cell.

The at least one first cell may be associated with at least one second base station.

The process may comprise causing the request to be sent from a base station other than the first base station.

The process may comprise causing the request to be sent from the second base station.

The process may comprise comprising causing the request to be transmitted in an X2 interface

The process may comprise determining the resource allocation to be sent in dependence of coordination architecture.

The coordination architecture may be a centralised coordination architecture or a distributed coordination architecture.

The request may include periodicity information.

The information relating to one or more resource allocations may be a configuration of one or more coordinated multipoint hypotheses.

The information relating to one or more resource allocations may be a list of one or more base stations and/or cells.

In the above, many different embodiments have been described. It should be appreciated that further embodiments may be provided by the combination of any two or more of the embodiments described above.

### LIST OF DRAWINGS

Embodiments will now be described, by way of example only, with reference to the accompanying Figures in which:

FIG. 1 shows a schematic diagram of an example communication system comprising a base station and a plurality of communication devices;

FIG. 2 shows a schematic diagram, of an example mobile communication device;

FIG. 3 shows an example of working procedure for a centralised coordination

FIG. 4 shows an example of working procedure for a distributed coordination;

FIG. 5 shows a flow diagram of an example of a method for receiving benefit metrics;

FIG. 6 shows a flow diagram of another example of a method for sending benefit metrics;

FIG. 7 shows an example architecture for performing a method of sending and receiving benefit metrics;

FIG. 8 shows a schematic diagram of an example control apparatus, module or unit;

### DESCRIPTION

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain also features, structures, units, modules etc. that have not been specifically mentioned.

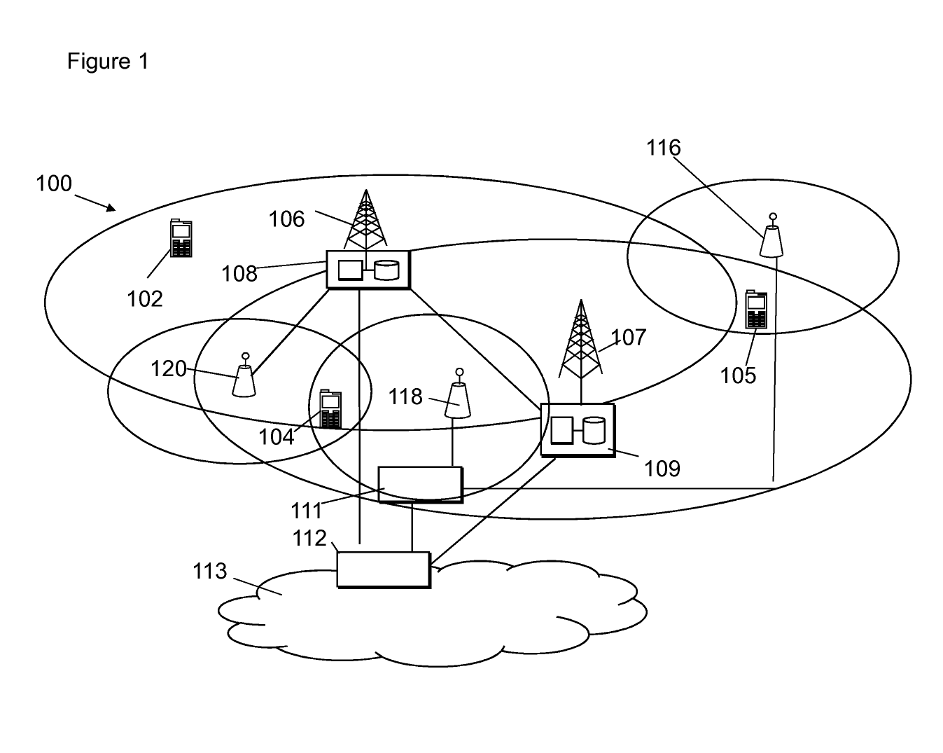

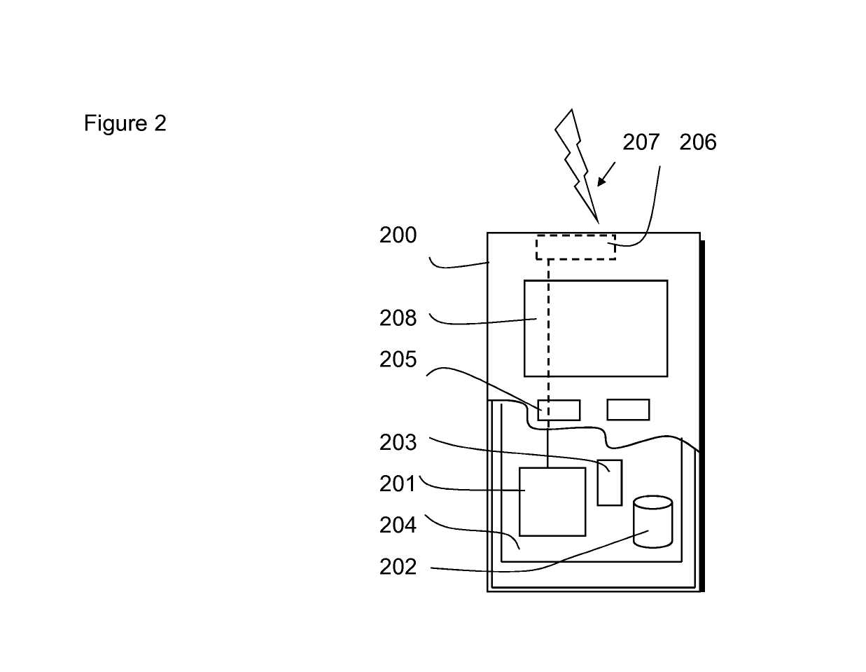

Before explaining in detail the examples, certain general principles of a wireless communication system and mobile communication devices are briefly explained with reference to FIGS. 1 to 2 to assist in understanding the technology underlying the described examples. It is obvious for a person skilled in the art that the embodiments may also be applied to other kinds of communications networks having suitable means by adjusting parameters and/or procedures appropriately.

In a wireless communication system 100, such as that shown in FIG. 1, mobile communication devices or user equipment (UE) 102, 104, 105 are provided wireless access via at least one base station or similar wireless transmitting and/or receiving node or point. Base stations are typically controlled by at least one appropriate controller apparatus, unit or module, so as to enable operation thereof and management of mobile communication devices in communication with the base stations. The controller apparatus may be part of the base station, node, host or server (and/or provided by a separate entity such as a Radio Network Controller). In FIG. 1 control apparatus 108 and 109 are shown to control the respective macro level base stations 106 and 107. The control apparatus of a base station can be interconnected with other control entities. The control apparatus is typically provided with memory capacity and at least one data processor. It should be appreciated that when the control apparatus is a part of a node (such as eNodeB), it may use memory capacity and one or more processors existing in the apparatus that is to say the resources used may be at least partially shared, not necessarily dedicated. The control apparatus and functions may be distributed between a plurality of control units.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations or nodes 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. In the example, stations 116 and 118 are connected via a gateway 111 whilst station 120 connects via the controller apparatus 108. In some embodiments, the smaller stations may not be provided.

A possible mobile communication device will now be described in more detail with reference to FIG. 2 showing a schematic, partially sectioned view of a communication device 200. Such a communication device is often referred to as user equipment (UE), device or terminal. An appropriate mobile communication device may be provided by any device capable of sending and receiving radio signals. Non-limiting examples include a mobile station (MS) or mobile device such as a mobile phone or what is known as a ‘smart phone’, a computer provided with a wireless interface card or other wireless interface facility (e.g., USB dongle), personal data assistant (PDA), handset, device using a wireless modem (alarm or measurement device, etc.), laptop and/or touch screen computer, tablet, game console, notebook or multimedia device provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. Users may also be provided broadcast or multicast data. Non-limiting examples of the content include downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Radio Link Control/Medium Access Control/Physical layer protocol (RLC/MAC/PHY) and control plane Radio Resource Control (RRC) protocol terminations towards the communication devices. Other examples of radio access system include those provided by base stations of systems that are based on technologies such as wireless local area network (WLAN) and/or WiMax (Worldwide Interoperability for Microwave Access).

Base stations, base station nodes, access points or Base Transceiver Stations (BTS) are widely used as part of cellular network based on Radio Access Technologies (RAT), like GSM, (W)CDMA or LTE. Typically a BTS comprises at least one Base Band Unit (BBU) and at least one Radio Unit (RU) or Remote Radio Unit (RRU). Within the BTS a dedicated protocol is used to achieve flexible handling of control and user plane data exchange, for example between the BBU and the (R)RU nodes inside the BTS topology. Common Public Radio Interface (CPRI) is one such protocol. Base stations may be co-located. In some situations, co-located base stations may share some hardware or may each have their own hardware.

Various methods of interference mitigation have been introduced in 3GPP specifications for increasing cell throughput and network capacity in LTE/LTE-A, such as eICIC (enhanced Inter-Cell Interference Coordination) in Rel. 10 and CoMP (Coordinated Multi-Point) in Rel. 11. In addition, further interference mitigation options are currently being developed for Rel. 12, including feICIC (further enhanced ICIC) and eCoMP (enhanced CoMP).

Typically, eICIC attempts to mitigate interference in Heterogeneous Networks (HetNets) by controlling in the time domain the transmissions of overlapping macro and small (low power) cells. A macro eNB provides so called “ABS (almost blank subframes) muting pattern” to the low power nodes that indicates the time slots during which the macro eNB transmits only certain reference signals that are mandatory for the legacy devices, but is otherwise muted. During these almost blank sub-frames, the low power nodes can schedule cell edge UEs that would otherwise suffer from high interference caused by the high power macro eNB. In order to achieve efficient use of radio resources, the macro eNB may dynamically adjust the ABS muting pattern to reflect the varying load and radio conditions. Similarly, eICIC may be applied also to mitigate interference between (high power) macro cells or between (low power) small cells.

With eCoMP, similar coordinated muting mechanisms are proposed, but the muting might be decided on a sub-frame level (for example, a new muting decision may be made for every 1 ms TTI, Transmission Time Interval) and per sub-band (for example, during same TTI only part of the overall band may be muted).

In the context of eCoMP different architecture options are available. One option is to use distributed architecture and extend the existing X2 interface. Alternatively, a centralized architecture with a centralized controller entity for LTE RAN, and an alternative interface between eNB and the centralized controller entity may be used. The term X2 is used herein to refer to any logical interface between base stations, and Xn to any logical interface between base stations and centralised coordination entities, that can be used to transmit information between the cells.

A CoMP hypothesis is a set of one or more hypothetical downlink (DL) resource allocations, where each resource allocation is associated with a Cell ID. Resource allocation is “muting per Physical Resource Block (PRB)” (i.e. no Tx power for that PRB). The CoMP Benefit (or Benefit Metric) quantifies the benefit that a cell of the reporting eNB expects in its scheduling when the associated CoMP hypothesis is assumed by the reporting eNB. The benefit value may be in the range 0 (no benefit) to 100 (maximum benefit).

The concept of eCoMP is under consideration in Rel. 12. In particular, how to define signaling to support inter-eNB coordination under non-ideal backhaul is being considered. Two type of coordination structure have been considered, namely centralized coordination and distributed coordination. In centralized coordination, a master-eNB may be responsible for collecting information from multiple slave-eNBs and making resource allocation decisions for them. Distributed coordination relies on peer-to-peer coordination to exchange information and each eNB may be able to determine its own resource allocation considering the input information from neighbors.

Since there is no new interface agreed for Rel. 12, coordination architecture should be invisible in the specification. In other words, X2 signaling may be enhanced for eCoMP to support both centralized and distributed coordination, a vendor may then decide which type of coordination to be implemented.

It has been proposed to associate benefit metric with a CoMP hypothesis. That is, to design one single message to include both benefit metric and associated with a CoMP hypothesis. A BM associated with one or more CoMP hypothesis, quantifies the benefit that a cell of the sender node expects in its scheduling when the associated CoMP hypothesis is assumed by the cell. The range of benefit metric in the X2 message may be specified. The method of deriving the cell-specific benefit metric may be specific to each eNB implementation. Scheduling benefit may be calculated as the gain of throughput. If throughput conditioned to neighbour cell's muting is TP1, and the throughput conditioned to neighbour cell's unmuting is TP2, then one example of calculating the benefit metric is: TP1-TP2. Another way is use normalized throughput, so the benefit metric is: (TP1-TP2)/(Average TP). Any suitable method of calculating the BM may be used, an eNB could consider many factors when calculating the scheduling benefit

The necessary time/frequency granularity and signaling period is the same as that of the associated CoMP hypothesis.

While the details of benefit metric design is up to RAN3, the basic principle has been determined by RAN1 where the benefit metric must be associated with a CoMP hypothesis. How to design the message is being considered.

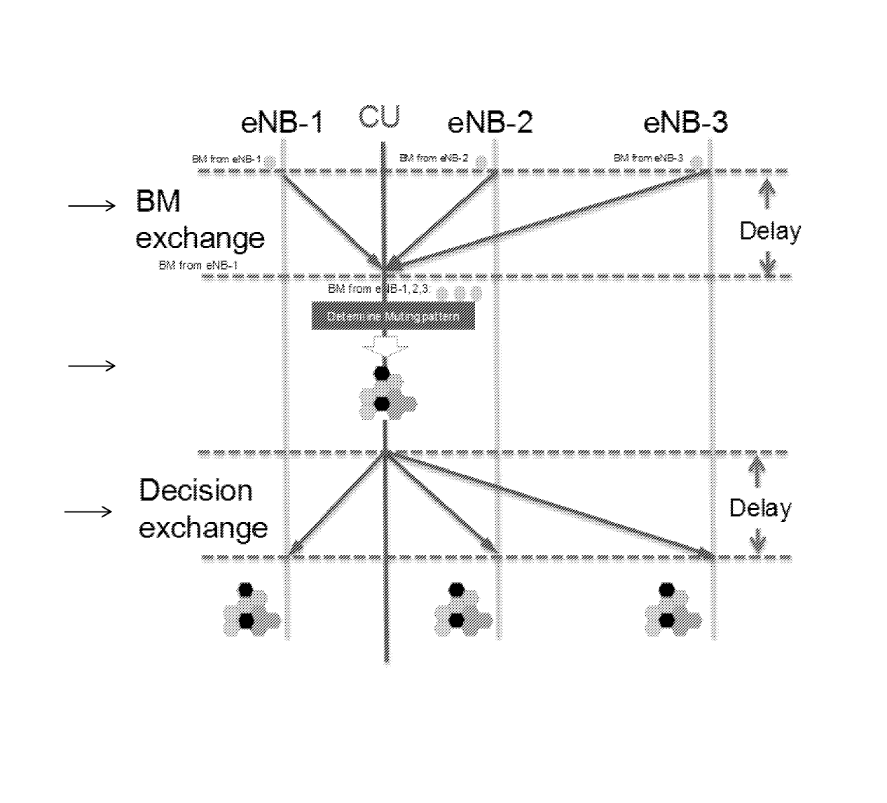

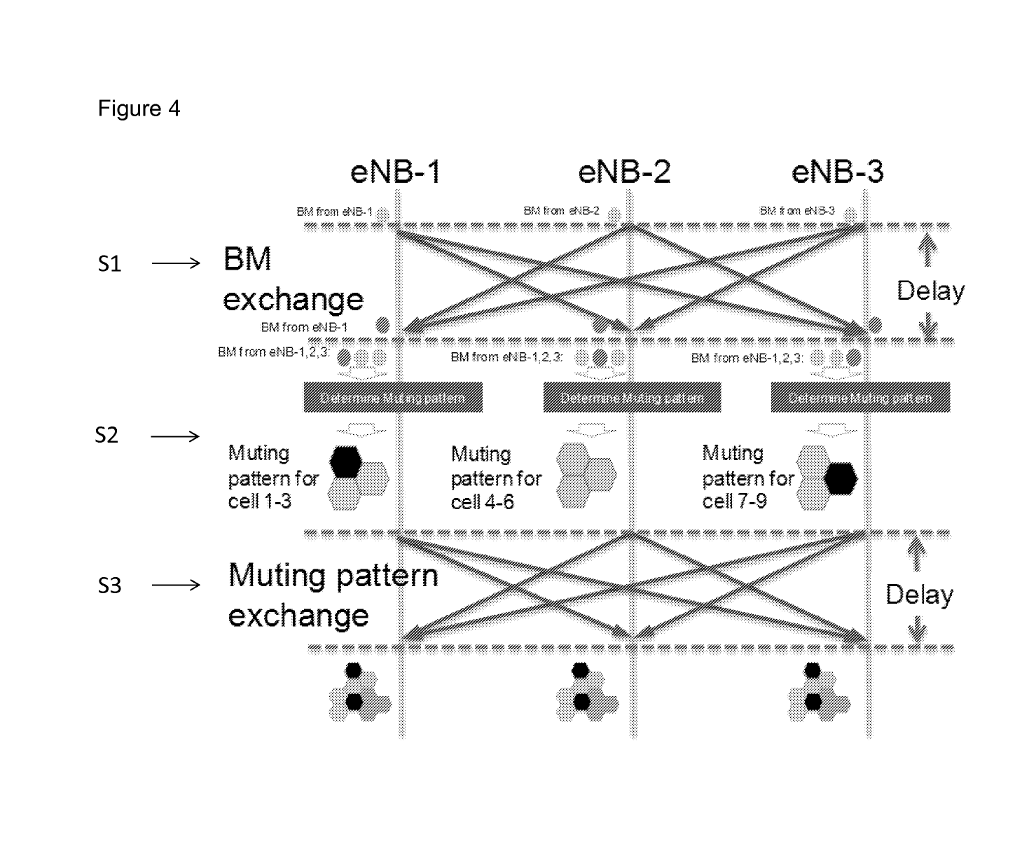

FIGS. 3 and 4 illustrate examples of how benefit metrics and CoMP hypothesis are signalled in centralized and distributed coordination. Centralised coordination architecture may be described as an architecture in which one base station sends a request to multiple base stations. Distributed coordination architecture may be described as an architecture where each base station sends a request to its neighbour base stations. In centralized coordination, as shown in FIG. 3, the benefit metric may be associated with a CoMP hypothesis with resource allocation of at least one neighbour cell. In step 1, an eNB sends multiple BMs to a centralised unit. Each BM represents a hypothetical benefit obtained if one or more neighbour cells applies a certain resource allocation (indicated by associated CoMP hypothesis). In step 2, considering the BM received from all eNBs, the centralised unit decides a muting pattern. In step 3 the centralised unit may distribute the muting decision to every eNB using the CoMP hypothesis.

In distributed coordination, as shown in FIG. 4, the benefit metric may be associated with a CoMP hypothesis with the resource allocation of only the receiving eNB. In step 1, the eNB sends a benefit metric to each neighbouring eNB. The BM represents the benefit obtained by the sender eNB if one cell of the receiving eNB applies a resource allocation according to the CoMP hypothesis. In step 2, considering the benefit metric received from all neighbouring eNBs, each eNB makes a muting decision on cells connecting to it. In step 3, the eNB sends the muting decision in the form of CoMP hypothesis (including the resource allocation for cells of the sending eNB.

If the CoMP hypothesis and benefit metric are included in the same message, the eNB sending the benefit metric may freely choose a CoMP hypothesis. However, considering the coordination type is invisible in the specification, one eNB may not be aware of the coordination type of another eNB. The eNB sending the benefit metric may not be aware of the coordination type that a receiving eNB is assuming. Therefore a sending eNB may have to include at least both the CoMP hypothesis about the receiving eNB (for distributed coordination) and the CoMP hypothesis about another neighbour cell (for centralised contribution). Since the receiving eNB may be operating distributed or centralised contribution it may not need both hypotheses, resulting in unnecessary overhead.

For centralized coordination, a slave-eNB should provide a BM conditioned to a neighbour cell's resource allocation. However, the slave-eNB may not know which neighbour cell is managed by the master eNB. A slave-eNB may send a benefit metric associated with a CoMP hypothesis about another eNB which is not managed by the Master-eNB. The slave-eNB may send a benefit metric associated with a CoMP hypothesis about some slave-eNB managed by the master-eNB. However, the Master-eNB may have no intention of changing the resource allocation on that eNB (due to, for example, high priority of traffic).

Designing a benefit metric associated with a pre-configured CoMP hypothesis in an on demand manner is considered.

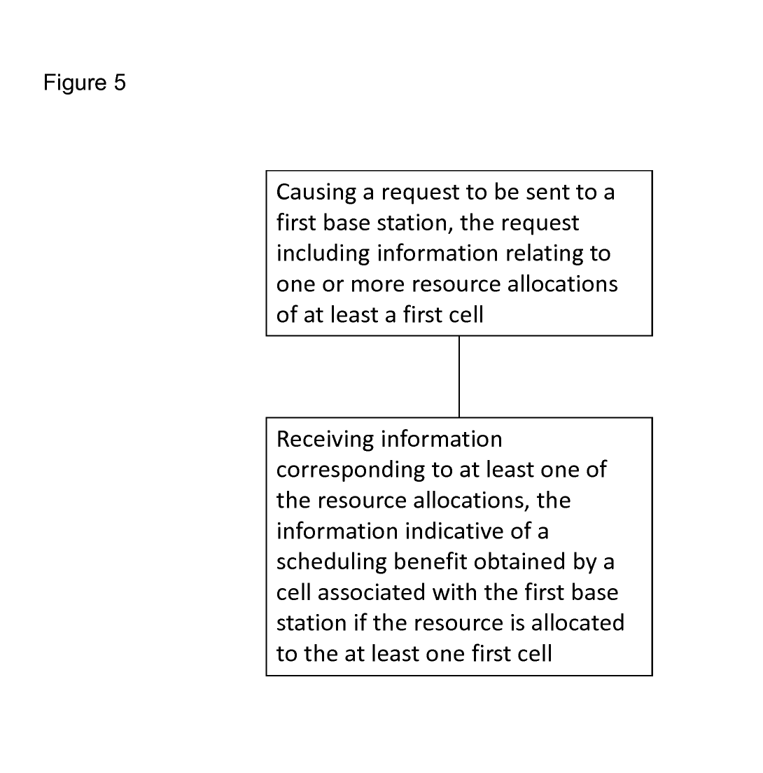

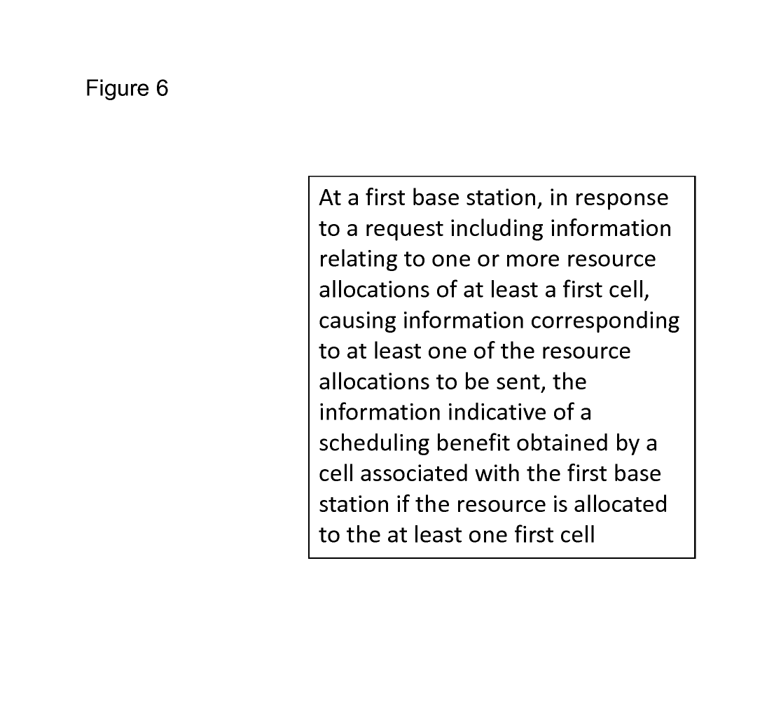

Examples of methods of sending and receiving a benefit metric associated with a CoMP hypothesis are shown in FIGS. 5 and 6. As shown in FIG. 5, a base station may send a request to another, first, base station. The request may include information relating to one or more resource allocations of at least a first cell. The first cell may be associated with the base station sending the request or it may be associated with another base station to the base station sending the request. The first cell may be associated with the base station receiving the request. At least one of the base stations may be an eNB. An eNB may send a request to another eNB asking the receiver eNB to report benefit metric(s). The request may include configuration of one or multiple CoMP hypotheses.

In response to the request, as shown in FIG. 6, the first base station is then caused to send, to the base station sending the request, information corresponding to at least one of the resource allocations, the information indicative of the scheduling benefit obtained by a cell associated with the first base station if the resource is allocated to the at least one first cell. The first base station, i.e the base station that receives the request, may send a benefit metric according to each of one or more configured CoMP hypotheses sent in the request. The base station may be an eNB. The benefit metric may be a value indicating the hypothetical benefit the receiver base station or eNB can obtain if the sender base station or eNB assumes the associated CoMP hypothesis. A CoMP hypothesis may include a resource allocation of a list of cells. A cell associated with a base station may be, for example, a pico cell managed by a master eNB or a cell of the base station or eNB

The receiver eNB may down-select a sub-set of configured CoMP hypotheses for sending benefit metric.

The base station requesting the benefit metric may be a master eNB in centralized coordination or a peer-to-peer eNB in distributed coordination. It can configure different set of CoMP hypotheses according to different coordination types.

In a potential alternative approach, a base station, for example an eNB, may send a request to another base station asking the receiver base station or eNB to report benefit metric(s). The request may include a list of eNBs/cells.

Upon receiving the request, an receiver eNB can decide a set of one or more CoMP hypotheses on its own but with the restriction that they cannot include any cells/eNBs which are not in the configured list of eNBs/cells.

Upon deciding on the CoMP hypotheses, the receiver eNB shall send a benefit metric along with the corresponding CoMP hypothesis back to the requesting eNB. The benefit metric may be a value indicating the hypothetical benefit the receiver eNB can obtain if the sender eNB assumes the associated CoMP hypothesis.

It should be understood that each block of the flowchart of FIG. 5 or 6 and any combination thereof may be implemented by various means or their combinations, such as hardware, software, firmware, one or more processors and/or circuitry.

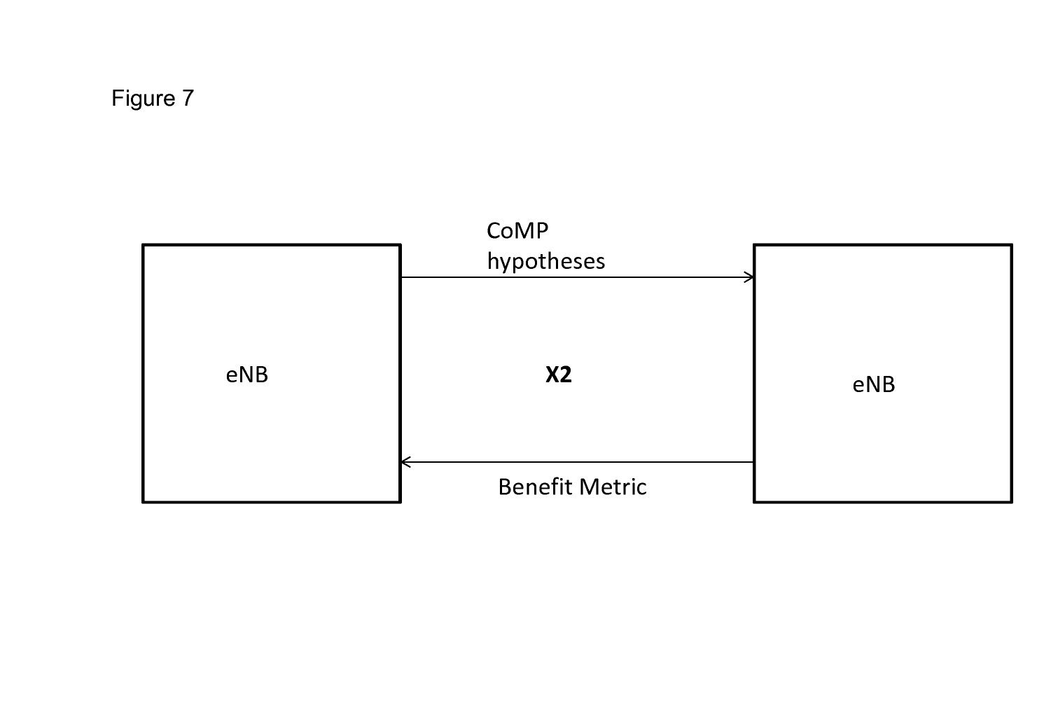

The method may be implemented in an architecture as shown in FIG. 7. FIG. 7 shows an example of an eNB which sends a request including CoMP hypotheses, and receives benefit metrics according to those CoMP hypotheses, to and from a second eNB over an X2 interface. An example apparatus comprises means for, at a first base station in response to a request including information relating to one or more resource allocations of at least a first cell and causing information corresponding to at least one of the resource allocations to be sent, the information indicative of a scheduling benefit obtained by a cell associated with the first base station if the resource is allocated to the at least one first cell. The means may be control apparatus 109 or located therein.

Another example apparatus comprises means for causing a request to be sent to a first base station, the request including information relating to one or more resource allocations of at least a first cell and means for receiving information corresponding to at least one of the resource allocations to be sent, the information indicative of a scheduling benefit obtained by a cell associated with the first base station if the resource is allocated to the at least one first cell. The means may be control apparatus 109 or located therein.

It should be understood that the apparatuses may include or be coupled to other units or modules such as radio parts or radio heads, used in or for transmission and/or reception. Although the apparatuses have been depicted as one entity in FIG. 7, different modules and memory may be implemented in one or more physical or logical entities.

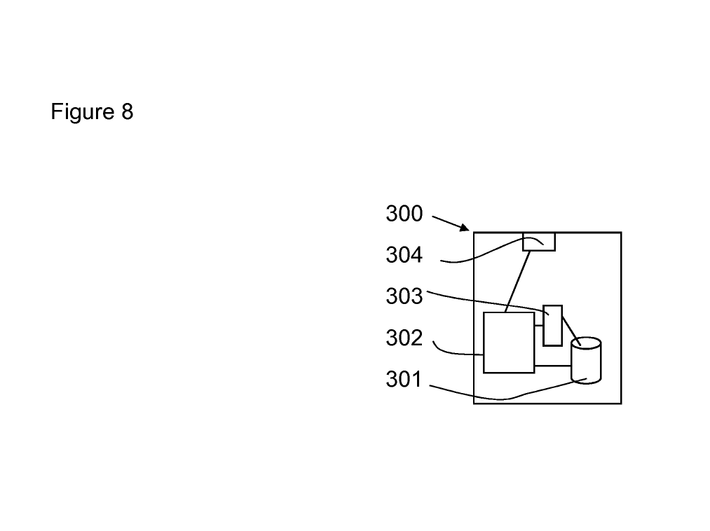

The method may be implemented on a control apparatus as shown in FIG. 8. FIG. 8 shows an example of a control apparatus, unit or module for a communication system, for example to be coupled to and/or for controlling a station of an access system, such as a base station or (e) node B, or a server or host. The control apparatus, unit or module may be a part of the (e)NodeB or it may be a remote apparatus, unit or module which the (e)NodeB is operationally coupled to. The control apparatus may be an apparatus via which the operator can manage the network configurations, e.g. NetAct OSS. The control apparatus 109 can be arranged to provide control on communications in the service area of the system. The control apparatus 109 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the control apparatus 109 can be configured to execute an appropriate software code to provide the control functions.

It is noted that whilst embodiments have been described in relation to LTE (and 3G), similar principles can be applied to any other communication system where coordinated multipoint is supported. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they include program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), FPGA, gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1-50. (canceled)

51. A method comprising, at a first base station in response to a request including information relating to one or more resource allocations of at least a first cell:
causing information corresponding to at least one of the resource allocations to be sent in a response, the information indicative of a scheduling benefit obtained by a cell associated with the first base station if the resource is allocated to the at least one first cell.

52. The method according to claim 51, wherein the at least one first cell is associated with at least one second base station.

53. The method according to claim 51 further comprising causing the response to be sent periodically.

54. The method according claim 51, wherein the request includes periodicity information.

55. The method according to claim 51, wherein the information relating to one or more resource allocations comprises at least one of the following:
one or more coordinated multipoint hypotheses; and
a list of one or more base stations and/or cells.

56. A method comprising:
causing a request to be sent to a first base station, the request including information relating to one or more resource allocations of at least a first cell; and
receiving information corresponding to at least one of the resource allocations, the information indicative of a scheduling benefit obtained by a cell associated with the first base station if the resource is allocated to the at least one first cell.

57. The method according to claim 56, wherein the at least one first cell is associated with at least one second base station.

58. The method according to claim 56, further comprising causing the request to be sent from a base station other than the first base station.

59. The method according to claim 56 wherein the request includes periodicity information.

60. The method according to claim 56, wherein the information relating to one or more resource allocations comprises at least one of the following:
a configuration of one or more coordinated multipoint hypotheses; and
a list of one or more base stations and/or cells.

61. An apparatus comprising:
at least one processor and at least one memory including a computer program code, the at least one memory and the computer program code configured to, with the at least one processor, cause the apparatus at least to: at a first base station in response to a request including information relating to one or more resource allocations of at least a first cell:
cause information corresponding to at least one of the resource allocations to be sent in a response, the information indicative of a scheduling benefit obtained by a cell associated with the first base station if the resource is allocated to the at least one first cell.

62. The apparatus according to claim 61, wherein the at least one first cell is associated with at least one second base station.

63. The apparatus according to claim 61 further comprising causing the response to be sent periodically.

64. The apparatus according any preceding claim 61, wherein the request includes periodicity information.

65. The apparatus according to claim 61, wherein the information relating to one or more resource allocations comprises at least one of the following:
one or more coordinated multipoint hypotheses; and
a list of one or more base stations and/or cells.

66. An apparatus comprising:
at least one processor and at least one memory including a computer program code, the at least one memory and the computer program code configured to, with the at least one processor, cause the apparatus at least to:
cause a request to be sent to a first base station, the request including information relating to one or more resource allocations of at least a first cell; and
receive information corresponding to at least one of the resource allocations, the information indicative of a scheduling benefit obtained by a cell associated with the first base station if the resource is allocated to the at least one first cell.

67. The apparatus according to claim 66, wherein the at least one first cell is associated with at least one second base station.

68. The apparatus according to claim 66, comprising causing the request to be sent from a base station other than the first base station.

69. The apparatus according to claim 66 wherein the request includes periodicity information.

70. The apparatus according to claim 66, wherein the information relating to one or more resource allocations comprises at least one of the following:
a configuration of one or more coordinated multipoint hypotheses; and
a list of one or more base stations and/or cells.
